(19) United States
(12) Patent Application Publication
(10) Pub. No.: US 2014/0237119 A1
(43) Pub. Date: Aug. 21, 2014

(54) OBJECT MIGRATION SYSTEM AND METHOD FOR WEB-BASED CONTENT SERVICE MIGRATION

(71) Applicant: Electronics and Telecommunications Research Institute, Daejeon-si (KR)

(72) Inventors: Yeon-Joon CHUNG, Daejeon-si (KR); Chang-Woo YOON, Daejeon-si (KR)

(73) Assignee: Electronics and Telecommunications Research Institute, Daejeon-si (KR)

(21) Appl. No.: 13/970,070

(22) Filed: Aug. 19, 2013

(30) Foreign Application Priority Data
Feb. 18, 2013 (KR) 10-2013-0017082

(51) Int. Cl. G06F 9/50

(52) U.S. Cl. CPC G06F 9/5027
USPC 709/226

(57) ABSTRACT

Provided is an object migration system for web-based content service migration according to the present invention including: two or more web-based terminals configured to deliver a request for web-based content service migration including object information and service web-based content through a received virtualization object and a web page; a virtualization server configured to allocate a new virtual machine on the basis of the object information received from one of the two or more web-based terminals and deliver a virtualization object generated from content corresponding to the received object information to another of the two or more web-based terminals, the another being a destination terminal corresponding to the received object information; and a web server configured to provide the web page to the two or more web-based terminals. The destination terminal services the same web-based content as serviced by the one web-based terminal, at the same time point.

### CROSS-REFERENCE TO RELATED APPLICATION

This application claims the benefit under 35 U.S.C. §119(a) of a Korean Patent Application No. 10-2013-0017082, filed on Feb. 18, 2013, the entire disclosure of which is incorporated herein by reference for all purposes.

### BACKGROUND

1. Field

The following description relates to a method of migrating and copying a web-based service, and more particularly, to a method of migrating and copying a web-based high-quality multimedia stream service to a terminal.

2. Description of the Related Art

Along with the widely using of a broadband wired or wireless network such as the Internet, all of a broadcast service, data service, and an application program service are provided over one network. Accordingly, a variety of content services such as web searching, video on demand (VoD), and video call can be provided by a variety of smart devices including a smart TV, unlike a conventional TV providing only broadcast contents. In such a tendency, standardization of HTML5, the most recent specification of hypertext markup language (HTML), is being carried out. HTML5 is a markup language for providing multimedia replay, gaming, image editing, etc. over a web page. HTML5 has definitions of API and web application functions such that functions suggested by a variety of wired or wireless terminals may be used. For example, API standardization is also being carried out for direct video communication between peers of a web browser.

Introduction of such network and web technologies has provided an N-screen environment where a user uses any service not only by one of a variety of terminals connecting to the Internet, such as a smart TV, a smartphone, and tablet PC, but also by the different types of devices without service interruption, or an environment where a user continues to use the service through a terminal of a person surrounding the user. Thus, the International Telecommunication Union Telecommunication Standardization Sector (ITU-T) defines, as standards, mechanisms for using a service, regardless of locations of users and types of terminals. The open IPTV forum (OIPF) is performing HTML5-based standardization on session mobility with respect to service migration.

In HTML5, a variety of objects are classified on a tag name basis, and object classification and grouping technologies capable of supporting object migration are supported. In the near future, the importance of high-quality content such as a 3D image and hologram will be increased in a broadcast field, and a virtualization technology for supporting high-quality media content in a low-quality or mobile terminal is expected to be developed. Accordingly, a virtualization service control for supporting HTML5, which will be required in the near future, will need a new session control solution depending on requirement of high-quality image service and diversity of characteristics of an existing cloud computing environment and terminal.

Basically, a virtualization server has a software layer referred to as a virtual machine monitor (VMM) or hypervisor, which is a core function for virtualization that provides multiple virtual system environments to one physical system. Also, the virtual system environment generated by the VMM is referred to as a virtual machine. A software execution environment provided by the virtual machine is referred to as a guest domain, and an operating system of the guest domain is referred to as a guest operating system (OS). The existing representative VMM includes Citrix Xen, VMware ESX/Workstation, Oracle VirtualBox, Microsoft Hyper-V, etc. In these virtualization platforms, a new virtual machine should be created for migration or copy of HTML objects. In this case, several technical problems about service migration should be solved in consideration of a virtualization object that has not been considered.

### SUMMARY

The following description relates to a virtualization service control technology capable of supporting HTML5 and thus a solution for effectively controlling HTML5 objects capable of accommodating diversity of characteristics of the existing cloud computing environment and terminal and requirement of high-quality image service.

In one general aspect, an object migration system for web-based content service migration according to the present invention includes: two or more web-based terminals configured to deliver a request for web-based content service migration including object information and service web-based content through a received virtualization object and a web page; a virtualization server configured to allocate a new virtual machine on the basis of the object information received from one of the two or more web-based terminals and deliver a virtualization object generated from content corresponding to the received object information to another of the two or more web-based terminals, the another being a destination terminal corresponding to the received object information; and a web server configured to provide the web page to the two or more web-based terminals. The destination terminal services the same web-based content as serviced by the one web-based terminal, at the same time point. The two or more web-based terminals may provide web (HTML5) based content through the generated virtualization object and web page.

In another aspect, the virtualization server includes a controller configured to allocate a new virtual machine on the basis of object information received from one of the two or more web-based terminals and deliver a virtualization object generated by the allocated virtual server to another of the two or more web-based terminals, the another web-based terminal being determined as a destination terminal according to the received object information; and two or more virtual machines configured to generate the virtualization object from content on the basis of the received object information. The two or more web-based terminals may provide web-based content through the generated virtualization object and web page. The generated virtualization object may be serviced as web (HTML5) based content through a web page. Here, the object information includes destination terminal information, service request information, and virtualization object information.

In still another aspect, an object migration method for web-based content service migration according to the present invention includes receiving a request for web-based content service migration received from any one of the two or more web-based terminals; allocating a new virtual machine on the basis of the request for web-based content service migration to allow the allocated virtual machine to generate a virtualization object; delivering the generated virtualization object to another of the two or more web-based terminals, the another web-based terminal corresponding to a destination terminal for the received request for web-based content service migration; and servicing the generated virtualization object through a web page.

The allocating of the new virtual machine on the basis of the received request for web-based content service migration to allow the allocated virtual machine to generate a virtualization object may include: determining whether the received request for web-based content service migration is about virtualization object migration; generating a new virtual terminal when the received request is about virtualization object migration; copying object information included in the received request for the web-based content service migration, to the generated virtual machine; generating a new virtualization object on the basis of the object information; and removing a previous virtual terminal and virtualization object.

If the received request for web-based content service migration is not about virtualization object migration, it is determined whether the received request is about virtualization object copy. Thus, if the received request is about virtualization object copy, the method generates a new virtual terminal, copies object information included in the received request to the generated virtual machine, and generates a new virtualization object on the basis of the object information.

Other features and aspects will be apparent from the following detailed description, the drawings, and the claims.

### BRIEF DESCRIPTION OF THE DRAWINGS

FIG. 1 is a block diagram showing an object migration system for web-based content service migration according to an embodiment of the present invention.

FIGS. 2A and 2B are detailed block diagrams showing an object migration system for web-based content service migration according to an embodiment of the present invention.

FIG. 3 is a flowchart illustrating the data flow of an object migration system for a web-based content service according to an embodiment of the present invention.

FIG. 4 is a flowchart illustrating an object migration method for web-based content service migration according to an embodiment of the present invention.

FIG. 5 is a flowchart illustrating an object management method for an object migration method for web-based content service migration according to an embodiment of the present invention.

FIG. 6 is a view showing an example of a web page script according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. Terms used herein are terms that have been selected in consideration of functions and effects in embodiments, and the meanings of the terms may be altered according to the intent of a user or operator, or conventional practice. Therefore, the meanings of terms used in the below-described embodiments confirm to definitions when defined specifically in the specification, but when there is no detailed definition, the terms should be construed as meanings known to those skilled in the art.

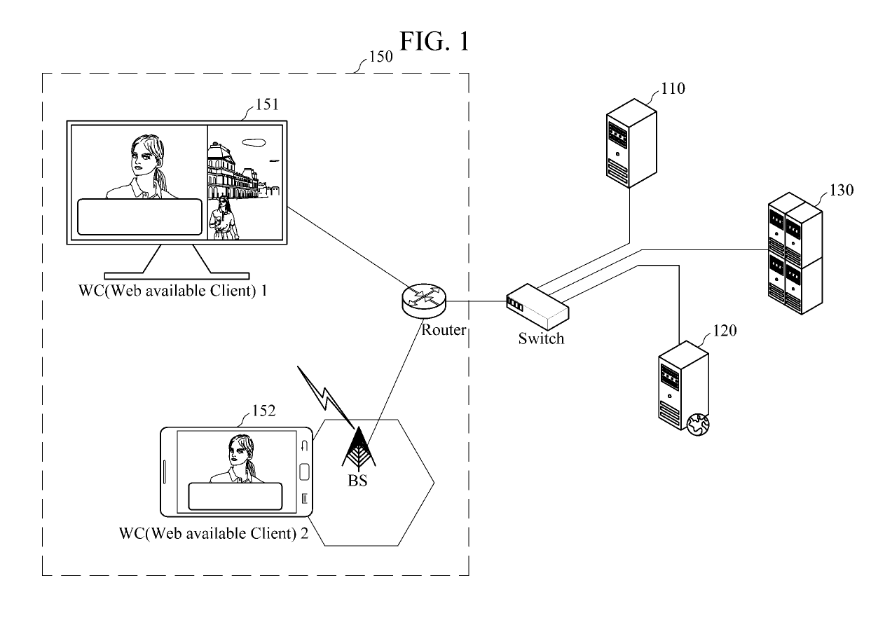

FIG. 1 is a block diagram showing an object migration system for web-based content service migration according to an embodiment of the present invention.

Referring to FIG. 1, the web-based content service migration system according to an embodiment of the present invention includes a content server 110, a web server 120, a virtualization server 130, and two or more web-based terminals 150.

The content server 110 stores a plurality of contents, and provides the virtualization server 130 with content requested by a user. A plurality of contents stored in the content server 110 include video, audio, and application programs for a web-based high-quality multimedia stream service such as HTML5.

The web server 120 stores information about multiple web pages, generates a web page object for a web page requested by a user, and delivers the generated web page object to one of the web-based terminals 150. Also, when the web server 120 receives a request for migration or copy of the object from one of the web-based terminals 150 to another, the web server 120 migrates or copies the web page object corresponding to the web page to the another web-based terminal. When a web page object is migrated from an old web-based terminal to a new web-based terminal, the web page object is deleted from the old web-based terminal. However, when a web page object is copied from an old web-based terminal to a new web-based terminal, the web page object is kept in the old web-based terminal and a new web page object is generated and then delivered to the new web-based terminal.

When the virtualization server 130 receives content from the content server 110, the virtualization server 130 allows a virtual terminal allocated to the virtualization server 130 to execute the received content, generates an object virtualized to be suitable for an environment of the web-based terminal 150, and then delivers the generated virtualization object to the web-based terminal 150.

When the virtualization server 130 receives a request for migration or copy of an object from one web-based terminal 150 provided with a web-based multimedia service through a virtualization object, to a new web-based terminal 150, the virtualization server 130 allocates a new virtual terminal and receives content for a new virtualization object from the content server 110. Subsequently, the virtualization server 130 allows the new virtual terminal to execute the received content to generate a new object virtualized to be suitable for an environment of the web-based terminal 150 and then delivers the generated new virtualization object to the new web-based terminal.

The web-based terminal 150 may connect to the Internet using a variety of communication methods, including wireless mobile communication such as 3GPP, LTE, and Wibro or a variety of communication methods such as a general LAN connection and a wireless LAN connection such as WiFi. The web-based terminal 150 may access a web page through the Internet connection and execute a variety of contents through the web page. In a system according to the present invention, there are two or more web-based terminals 150.

The web-based terminal 150 receives a web page object from the web server 120, and receives a virtualization object from the virtualization server 130. A system allowing a web-based multimedia service such as hypertext markup language 5 (HTML5) can provide a high-quality multimedia service to a web page (web browser) without a separate platform such as Flash. To this end, the web server 120 generates and delivers a web page object for a web page upon a user's request. The high-quality multimedia content such as video content which is executed or represented at the web page receives a virtualization object through the virtual terminal of the virtualization server 130. Thus, a user may use the high-quality multimedia at the web page. The virtualization server 130 and the web-based terminal 150 operate with server and client networking, using a transfer protocol such as HTTP, web socket, etc.

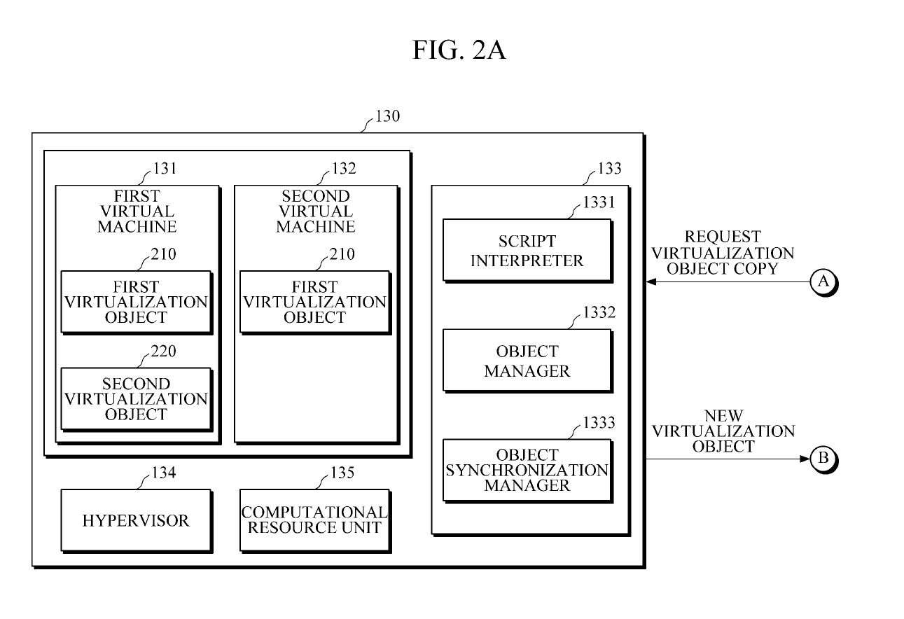

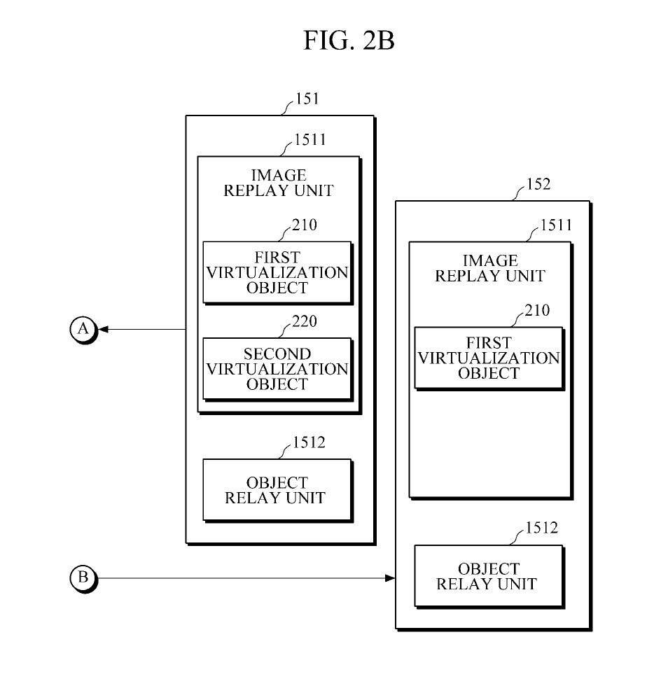

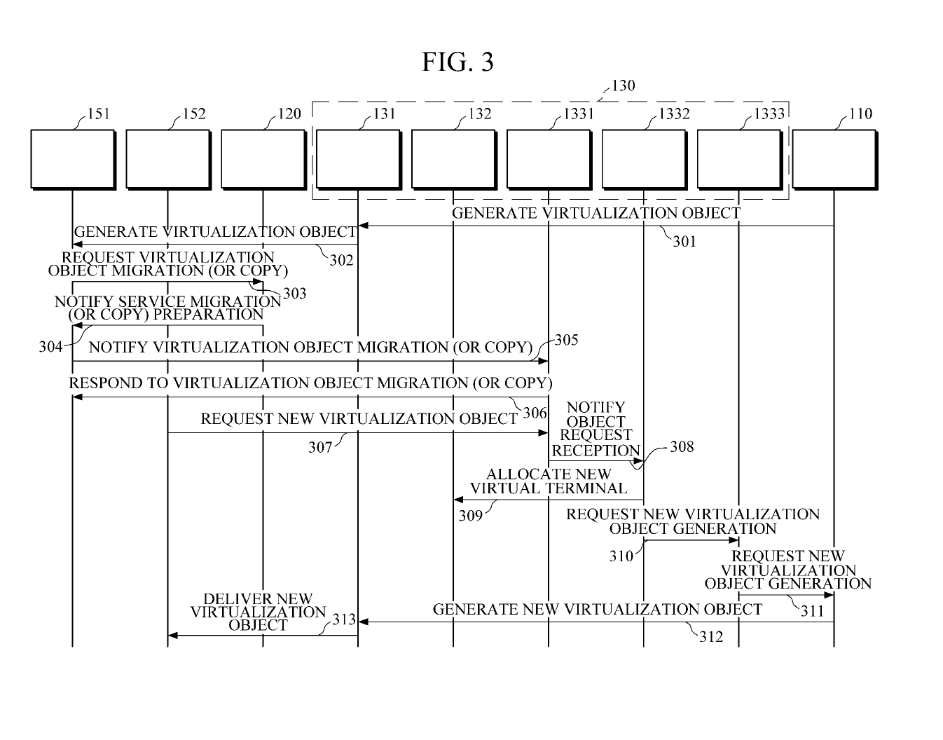

The present invention can generate a virtualization object for a piece of content selected from among two or more pieces of web-based content that are provided by a first web-based terminal 151, using the content server 110, the virtualization server 130, and the web server 120, to migrate or copy to a second web-based terminal 152, thereby performing migration of a web-based content service. A detailed description of virtualization object migration (or copy) will be made with reference to FIGS. 2 and 3.

FIGS. 2A and 2B are detailed block diagrams showing an object migration system for web-based content service migration according to an embodiment of the present invention.

Referring to FIGS. 2A and 2B, the virtualization server 130 of the object migration system for web-based content service migration according to an embodiment of the present invention includes a first virtual machine 131, a second virtual machine 132, a controller 133, a hypervisor 134, and a computational resource unit 135.

The first virtual machine 131 and the second virtual machine 132 are virtual machines of the virtualization server 130, which are allocated some of computational resources of the computational resource unit 135 by the hypervisor 134. The first virtual machine 131 and the second virtual machine 132 have a virtual OS and a virtual driver installed therein to be operated like one independent terminal. The first virtual machine 131 and the second virtual machine 132 execute the received content on a virtual machine to generate a virtualization object, and then deliver the generated virtualization object to the web-based terminal 150.

The controller 133 includes an interpreter 1331, an object manager 1332, and an object synchronization manager 1333. The controller 133 manages a virtualization object generated by the virtual machines 131 and 132 and manages synchronization between the virtualization object of the virtual machine 131 and 132 and the virtualization object delivered to the web-based terminal 150. Also, the controller 133 is responsible for connection of HTML5 based-script between the web-based terminal 150 and the virtualization server 130.

The hypervisor 134 is a middleware between the virtual machines 131 and 132 and the computational resource unit 135, which allocates system resources of the computational resource unit 135 of the virtualization server 130 to generate the virtual machines 131 and 132 and install a virtual OS and a virtual driver to each of the generated virtual machines 131 and 132.

The computational resource unit 135 includes system resources included in the virtualization server 130. The computational resource unit 135 may include a central processing unit (CPU) resource, a memory resource, a network resource, a graphics processing unit (GPU) resource, and a storage resource. The predetermined amount of system resources of the computational resource unit 135 is allocated to the virtual machines 131 and 132 by the hypervisor 134.

The web-based terminal 150 of the object migration system for web-based content service migration according to an embodiment of the present invention includes the first web-based terminal 151 and the second web-based terminal 152. The first web-based terminal 151 includes an image replay unit 1511 and an object relay unit 1512.

The image replay unit 1511 replays an image about connection to a web page, which is delivered from the web server 120, on a screen and replays the virtualization object delivered from the virtualization server 130 on a web page screen to provide the virtualization object to a user. That is, the user may receive virtualized content through the web page screen, using the screen of the image replay unit 1511.

The object relay unit 1512 delivers the virtualization object received from the virtualization server 130, to the image replay unit 1511, and delivers a control signal generated by a user's input, from the first web-based terminal 151 to the first virtual machine 131 of the virtualization server 130. The object relay unit 1512 controls synchronization between virtualization objects of the first virtual machine 131 and the first web-based terminal 151.

Referring to FIGS. 2A and 2B, two virtual machines including the first virtual machine 131 and a second virtual machine 132 are allocated to the virtualization server 130. Two virtualization objects including a first virtualization object 210 and a second virtualization object 220 are generated in the first virtual machine 131. The first virtualization object 210 and the second virtualization object 220 generated in the first virtual machine 131 are delivered to the first web-based terminal 151 over a network. The first virtualization object 210 and the second virtualization object 220 delivered to the first web-based terminal 151 are serviced to a user through the web page.

When the virtualization server 130 receives a signal for requesting migration or copy of a service corresponding to the second virtualization object 220 from the first web-based terminal 151 to the second web-based terminal 152, the virtualization server 130 receives content corresponding to the second virtualization object 220 from the content server 110 to execute the received content in the second virtual machine 132, and delivers the second virtualization object 220 based on the content received from the second virtual machine 132, to the second web-based terminal 152.

Data flow between the virtualization server 130 and the first and second web-based terminals 151 and 152 will be described below in detail with reference to FIG. 3.

FIG. 3 is a flowchart illustrating the data flow of an object migration system for a web-based content service according to an embodiment of the present invention.

Referring to FIG. 3, in the data flow of the object migration system for the web-based content service according to an embodiment of the present invention, first, a first virtual machine 131 receives content from a content server 110 to execute the received content to generate a virtualization object (301). When the content server 110 receives a user service request, the content server 110 delivers the corresponding content to the first virtual machine 131. The first virtual machine 131 executes the received content, using the allocated computational resource, to generate the virtualization object. The first virtual machine 131 delivers the generated virtualization object to a first web-based terminal 151 (302). The first web-based terminal 151 may be provided with a web page-based content service through the virtualization object provided from the first virtual machine 131 of a virtualization server and the web page provided through a web server 120.

The first web-based terminal 151 sends, to the web server 120, a request for service migration (or copy) to a second web-based terminal 152 (303). A user receives a web (HTML5) based content service through the virtualization object received by the first web-based terminal 151. If the user desires to change his/her terminal from the first web-based terminal 151 to the second web-based terminal 152 to receive the same service as before, or the user desires to receive the same web-based content service as received through the first web-based terminal 151, through the second web-based terminal 152, the user sends a request for object migration or copy to the second web-based terminal 152. The request for service migration (or copy) includes object information. The object information includes information about a destination terminal (here, the second web-based terminal) to be migrated, content information, web page information, and virtualization object information. The web server 120 receives and stores web page information, content information, and content link information from the first web-based terminal 151, and notifies the first web-based terminal 151 of completion of preparation for service migration (or copy) (304).

When the first web-based terminal 151 receives the completion of web page object migration (or copy), the first web-based terminal 151 delivers the migration (or copy) of virtualization object into a script interpreter 1331 of the virtualization server 130 (305). When the script interpreter 1331 receives the migration (or copy) of the virtualization object, the script interpreter 1331 delivers a response to migration (or copy) of the virtualization object (306).

The second web-based terminal 152 sends a request for the virtualization object according to migration (or copy) to the script interpreter 1331 (307). To migrate or copy a web-based content service from the first web-based terminal 151 to the second web-based terminal 152, the second web-based terminal 152 sends a request for virtualization object to the script interpreter 1331 to receive a virtualization object for the corresponding content when the second web-based terminal 152 receives an object migration (or copy) notification for migration of the content from the first web-based terminal 151 to the virtualization server 130.

Next, the script interpreter 1331 notifies the object manager 1332 of the reception of virtualization object request from the second web-based terminal 152 (308) when the script interpreter 1331 receives a virtualization object request caused by migration or copy from the second web-based terminal 152. The object manager 1332 allocates a second virtual machine 132 into the virtualization server 130. The object manager 1332 allocates the new second virtual machine 132 into the virtualization server 130 to provide the second web-based terminal 152 with the web-based content service when the object manager 1332 receives a virtualization object request reception notification from the scrip interpreter 1331. The second virtual machine 132 is formed by receiving a predetermined amount of CPU, GPU, memory, and network resources of the virtualization server 130.

The object manager 1332 delivers a new virtualization object generation request to an object synchronization manager 1333 (310). The object synchronization manager 1333 delivers the received virtualization object generation request to the content server 110 (311). When the content server 110 receives the virtualization object generation request from the object synchronization manager 1333, the content server 110 delivers the corresponding content to the second virtual machine 132 on the basis of the received virtualization object generation request (312). The content server 110 delivers, to the second virtual machine 132, the same content as provided through the web-based content service that was provided to the first web-based terminal 151 in order to generate a new virtualization object. When the second virtual machine 132 receives the content from the content server 110, the second virtual machine 132 executes the received content to generate a virtualization object and then delivers the generated virtualization object to the second web-based terminal 152 (313). When the second virtual machine 132 receives the virtualization object, the second virtual machine 132 may receive a web page-based content service through the received virtualization object and a web page provided from the web server 120.

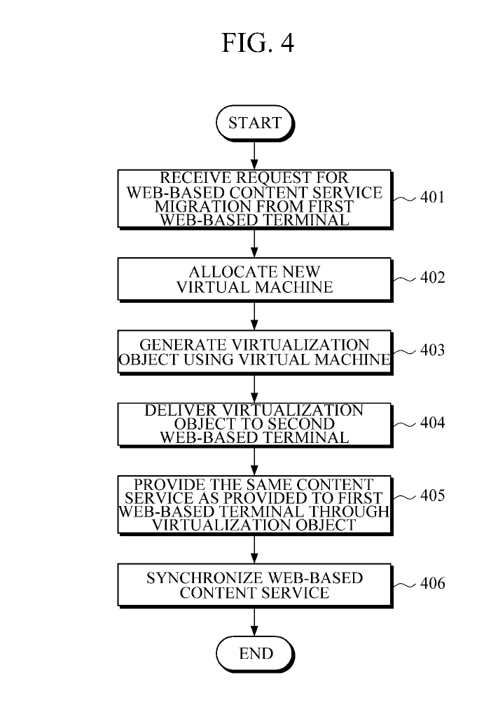

FIG. 4 is a flowchart illustrating an object migration method for web-based content service migration according to an embodiment of the present invention.

Referring to FIG. 4, the object migration method for web-based content service migration according to an embodiment of the present invention first receives a request for web-based content service migration (or copy) from a first web-based terminal currently receiving a web-based content service to a second web-based terminal (401). When a user receiving a web-based content service through the first web-based terminal desires to receive the same web-based content service as that of the first web-based terminal through the second web-based terminal instead of the first web-based terminal, the object migration method receives, from the first web-based terminal, a request for migration (or copy) of the web-based content service to the second web-based terminal.

Next, the object migration method allocates a new virtual machine to a virtualization server (402). When the request for migration (or copy) of the web-based content service to the second web-based terminal is received from the first web-based terminal, the object migration method allocates the new virtual machine by allocating a predetermined computational resources into the virtualization server in order to generate a virtualization object to be provided to the second web-based terminal.

The object migration method allows the new allocated virtual machine to execute the same content as that of the first web-based terminal to generate a virtualization object (403). The web-based content service of the present invention is a service providing, through a web page, the virtualization object generated from the corresponding content. To this end, the virtualization object for the content is generated in the new allocated virtual machine. When the virtualization object is generated, the object migration method delivers the generated virtualization object to the second web-based terminal (404). The object migration method provides the web-based content service on the basis of the virtualization object delivered to the second web-based terminal (405). The second web-based terminal can provide the same web-based content service as that of the first web-based terminal, by providing the received virtualization object through a web page provided from a web server. Also, the object migration method synchronizes a web-based content service provided to the second web-based terminal with a web-based content service having been provided to the first web-based terminal (406). Thus, the user may receive the same web-based content service anywhere at any time, regardless of the type of a terminal being used. For example, a user watching a video on a web page using a smartphone while coming home after work may watch the same video on a smart TV in his or her living room from a scene in the video having been watched by the user.

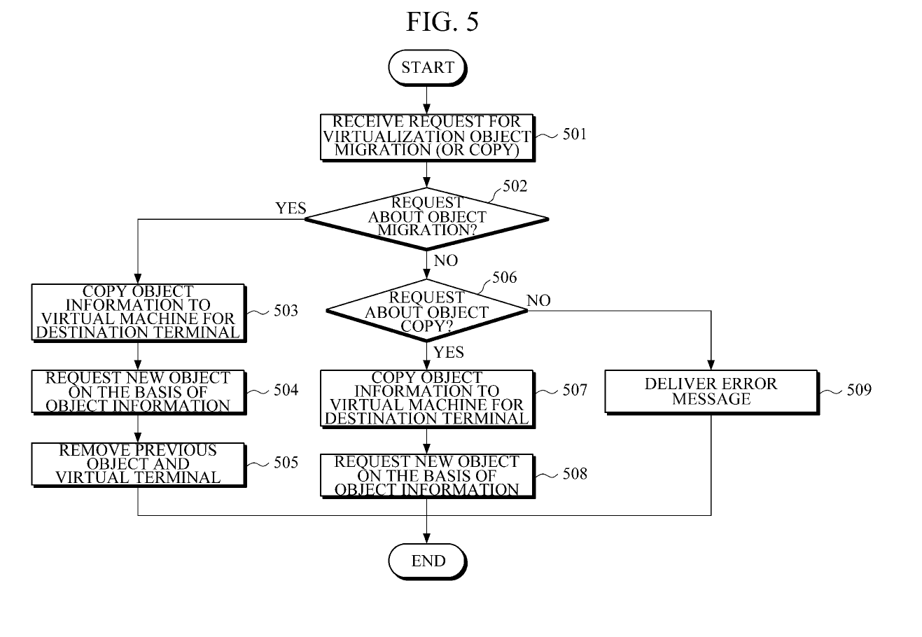

FIG. 5 is a flowchart illustrating an object management method for an object migration method for web-based content service migration according to an embodiment of the present invention.

Referring to FIG. 5, the object management method for an object migration method for web-based content service migration according to an embodiment of the present invention first receives a virtualization object migration (or copy) request and object information (501). When the virtualization object migration (or copy) request is received from a web-based terminal, the method proceeds to a routine for virtualization object migration or copy on the basis of the received request. The received request includes object information such as destination terminal information and content information.

The method determines whether the received request is about virtualization object migration (502). The web-based content service may be migrated or copied to a new web-based terminal according to a user's request, thereby being continuously provided. Accordingly first, the method determines whether the received request is about virtualization object migration.

If it is determined in operation 502 that the received request is about virtualization object migration, the method copies object information to a virtual machine for a destination terminal (503). The method requests a new object on the basis of the object information including destination terminal information and content information (504). The object information includes the destination terminal information and content information. The destination terminal information may be information about a terminal to which the web-based content service is to be migrated, which include IP information and the type of the terminal. Next, the method completes an object of the previous terminal and removes the previous virtual terminal (505). If the received request is about virtualization object migration, the web-based content service is migrated from the current web-based terminal to the destination terminal to be provided. Accordingly, the virtualization object of the current web-based terminal is completed, and resources of a virtual machine formed corresponding to the current web-based terminal are released. In this case, only the virtual machine and virtualization object for the destination terminal are maintained. Thus, a user may receive the same web-based content service as before, even though the user has changed his/her terminal.

If it is determined in operation 502 that the received request is not about virtualization object migration, the method determines whether the received request is about virtualization object copy (506). If it is determined in operation 506 that the received request is about virtualization object copy, the method copies the object information to the virtual machine for the destination terminal (507). The method requests a new object on the basis of the object information including destination terminal information and content information (508). If the received request is about virtualization object copy, the method allocates a virtual machine and requests a new object in the same manner as operations 303 and 304. However, if the received request is about virtualization object copy, the object and virtual machine are maintained the same in both the current web-based terminal and the destination terminal, unlike completing the virtualization object of the current web-based terminal and releasing the virtual machine. Thus, the user may receive the same web-based content service through two terminals at the same time.

If it is determined in operation 506 that the received request is not about virtualization object copy, the method determines the request as an incomplete request to deliver an error message to the web-based terminal (509). If the request is about neither virtualization object copy nor virtualization object migration, the request is determined as an incomplete request. Accordingly, the method delivers an error message to the web-based terminal having delivered the request to notify the web-based terminal that the request is incomplete.

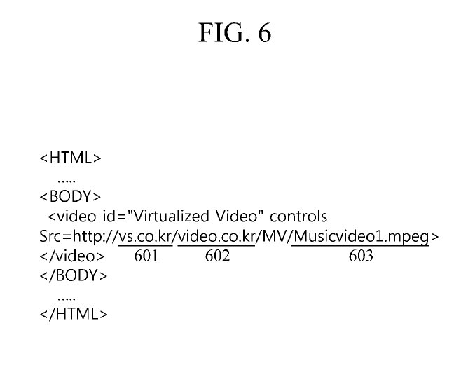

FIG. 6 is a view showing an example of a web page script according to an embodiment of the present invention.

Referring to FIG. 6, a web page according to an embodiment of the present invention contains an HTML script that is used to virtualize “Musicvideo1.mpeg” file, which is content 603 in a content server address 602 and thus service a web page-based content. When a web-based terminal opens the web page and then executes the content, “Musicvideo1.mpeg” content 603 is read by a content server 602 through a script interpreter of a virtualization server 601, virtualized by a virtual machine, and then delivered to the web-based terminal.

The object migration service for web-based content service migration and the method thereof according to the present invention can enable effective migration and copy of the virtualized objects to a variety of N-screens, thereby providing object efficiency, entirely enhancing resource efficiency of the virtual server, and effectively providing a high-quality multimedia service based on a web environment for a variety of user terminal environments.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtualization server for web-based content service migration, which provides a web-based content service to two or more web-based terminals, the virtualization server comprising:
a controller configured to allocate a new virtual machine on the basis of object information received from any one of the two or more web-based terminals and deliver a virtualization object generated by the allocated virtual server to another of the two or more web-based terminals, the another web-based terminal being determined as a destination terminal according to the received object information; and
two or more virtual machines configured to generate the virtualization object from content on the basis of the received object information.

2. The virtualization server of claim 1, wherein the two or more web-based terminals provide web-based content through the generated virtualization object and a web page.

3. The virtualization server of claim 1, wherein the generated virtualization object is serviced as web (HTML5) based content to a user through a web page.

4. The virtualization server of claim 1, wherein the object information comprises at least one of destination terminal information, service request information, and virtualization object information.

5. The virtualization server of claim 1, wherein the controller is configured to deliver the generated virtualization object to another destination terminal corresponding to the received object information and delete a previous virtual machine and virtualization object.

6. An object migration method for web-based content service migration, which provides a web-based content service to two or more web-based terminals, the object migration method comprising:
receiving a request for web-based content service migration received from any one of the two or more web-based terminals;
allocating a new virtual machine on the basis of the request for web-based content service migration to allow the allocated virtual machine to generate a virtualization object;
delivering the generated virtualization object to another of the two or more web-based terminals, the another web-based terminal corresponding to a destination terminal for the received request for web-based content service migration; and
servicing the generated virtualization object through a web page.

7. The object migration method of claim 6, wherein the allocating of the new virtual machine on the basis of the received request for web-based content service migration to allow the allocated virtual machine to generate a virtualization object comprises:
determining whether the received request for web-based content service migration is about virtualization object migration; generating a new virtual terminal when the received request is about virtualization object migration;
copying object information included in the received request for the web-based content service migration, to the generated virtual machine;
generating a new virtualization object on the basis of the object information; and
removing a previous virtual terminal and virtualization object.

8. The object migration method of claim 7, wherein the allocating of the new virtual machine on the basis of the received request for web-based content service migration to allow the allocated virtual machine to generate a virtualization object further comprises: determining whether the received request for web-based content service migration is about virtualization object copy if the received request for web-based content service migration is not about virtualization object migration;
generating a new virtual terminal if the received request is about virtualization object copy;
copying object information included in the received request for the web-based content service migration, to the generated virtual machine; and
generating a new virtualization object on the basis of the object information.

9. The object migration method of claim 6, wherein the two or more web-based terminals provide web-based content through the generated virtualization object and the web page.

10. The object migration method of claim 6, wherein the generated virtualization object is serviced as web (HTML5) based content to a user through the web page.

11. The object migration method of claim 6, wherein the received request for web-based content service migration comprises at least one of destination terminal information, service request information, and virtualization object information.

12. The object migration method of claim 6, further comprising delivering the generated virtualization object to another destination terminal according to the received request for web-based content service migration and then deleting the previous virtual machine and virtualization object.

13. An object migration system for web-based content service migration, the object migration system comprising:
two or more web-based terminals configured to deliver a request for web-based content service migration including object information and service web-based content through a received virtualization object and a web page;
a virtualization server configured to allocate a new virtual machine on the basis of the object information received from one of the two or more web-based terminals and deliver a virtualization object generated from content corresponding to the received object information to another of the two or more web-based terminals, the another being a destination terminal corresponding to the received object information; and
a web server configured to provide the web page to the two or more web-based terminals.

14. The object migration system of claim 13, wherein the destination terminal services the same web-based content as serviced by the one web-based terminal at the same time point.

15. The object migration system of claim 13, wherein the two or more web-based terminals provide web (HTML5) based content through the generated virtualization object and web page.
